(19) United States
(12) Patent Application Publication
(10) Pub. No.: US 2012/0214055 A1
(43) Pub. Date: Aug. 23, 2012

(54) GALVANIC CELL COMPRISING A FRAME, AND METHOD FOR THE PRODUCTION THEREOF

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/390,544

(22) PCT Filed: Jul. 29, 2010
(86) PCT No.: PCT/EP2010/004649

§ 371 Date: May 7, 2012

(30) Foreign Application Priority Data
Aug. 17, 2009 (DE) 10 2009 037 726.3

(51) Int. Cl. H01M 2/10; H01M 6/00

(52) U.S. Cl. 429/186; 29/623.1

(57) ABSTRACT

Disclosed is a frame for a galvanic cell consisting of an electrode stack that has a foil-type package, out of which at least two current collectors are brought. Said frame is designed so as to be able to be fixedly connected to the package of the cell when the cell is produced. When producing such a galvanic cell, a frame is fixedly connected to the package as the package is sealed.

The present invention relates to a galvanic cell comprising a frame and a method for the production thereof. Cells designed flat or rectangular (battery cells, capacitors, etc.) are known, the electrochemically active content whereof is surrounded by a foil-type package, for example a thin aluminium foil, which is plastic-coated on both sides, electrical connections in sheet-metal form (so-called “current collectors”) being passed through the latter. As distinct from other cell designs, the package of such cells is not live, since the current collectors are passed insulated through the package. Battery cells designed in this way are referred to as pouch cells or also as coffee-bag cells.

In various applications, e.g. in electric or hybrid vehicles, individual galvanic cells are connected in series and/or in parallel and are often located with accompanying electronics in a housing. On account of the often not very great mechanical loading capacity of pouch cells welded into a foil, the latter often cannot be incorporated directly into the battery housing, but first have to be mechanically stabilised by means of suitable supporting structures.

The problem underlying the present invention is to facilitate the use and the handling of galvanic cells and to alleviate the problems associated with the sensitivity of their package foil or, if possible, to solve the same. This problem is solved by a product and a method according to any one of the independent claims.

According to the invention, a frame is provided for a galvanic cell. The cell essentially comprises an electrode stack and a foil-type package, from which at least two current collectors are led out. The frame is constituted such that it can be fixedly connected to the package of the cell during the production of the cell. In the method according to the invention for the production of a galvanic cell, a frame is fixedly connected to the package as the package is sealed.

Several terms used in the subsequent description in the invention are explained below.

The term electrode stack is used as a designation for the electrochemically active content of a galvanic cell of any design. In contrast with this, the package of a cell is understood to mean the material not participating in the electrochemical reaction, said material closing off the electrode stack from the surroundings.

When mention is made of a foil-type package in this connection, this should be understood to mean all kinds of packages or enclosures that perform the function of shielding or closing off the electrode stack effectively against the environment, preferably with a small use of material. The closure should act against the transfer of matter or of electric currents. This term, however, also covers not only foils in the usual sense, but also in particular plastic-coated metal foils.

Within the meaning of the invention, current collectors refer to electrical conductors which are led to the exterior through the package, in order that a transport of electric charge can take place into the cell or out of the cell.

A frame within the meaning of the invention should be understood to mean any structural arrangement which is suitable for stabilising the cell mechanically against environmental influences and which can be connected fixedly to the package of the cell during the production of the cell. As the selection of words already indicates, a frame is preferably an essentially frame-like arrangement, the function whereof essentially consists in endowing a galvanic cell with mechanical stability.

Advantageous developments of the invention emerge from the sub-claims.

The invention is described in greater detail below on the basis of preferred examples of embodiment and with the aid of figures. In the figures:

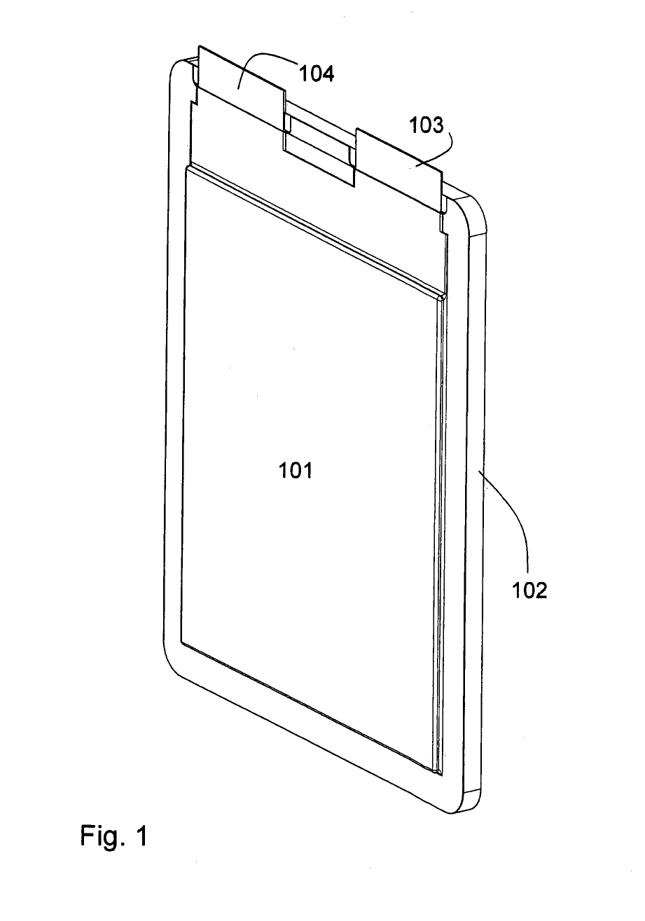

FIG. 1 shows a view of an example of embodiment of the cell according to the invention with an integrated frame from the front;

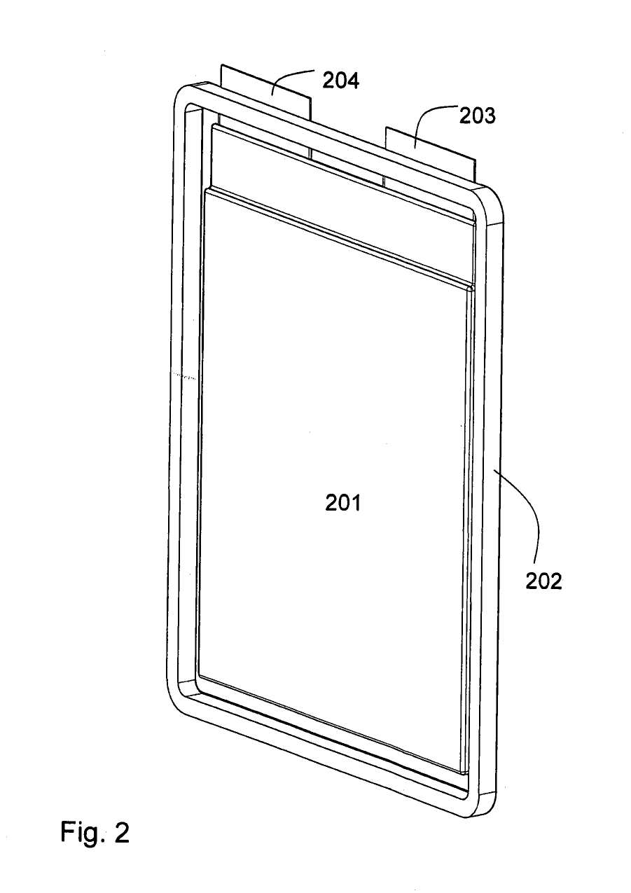

FIG. 2 shows a view of the same example of embodiment from the rear;

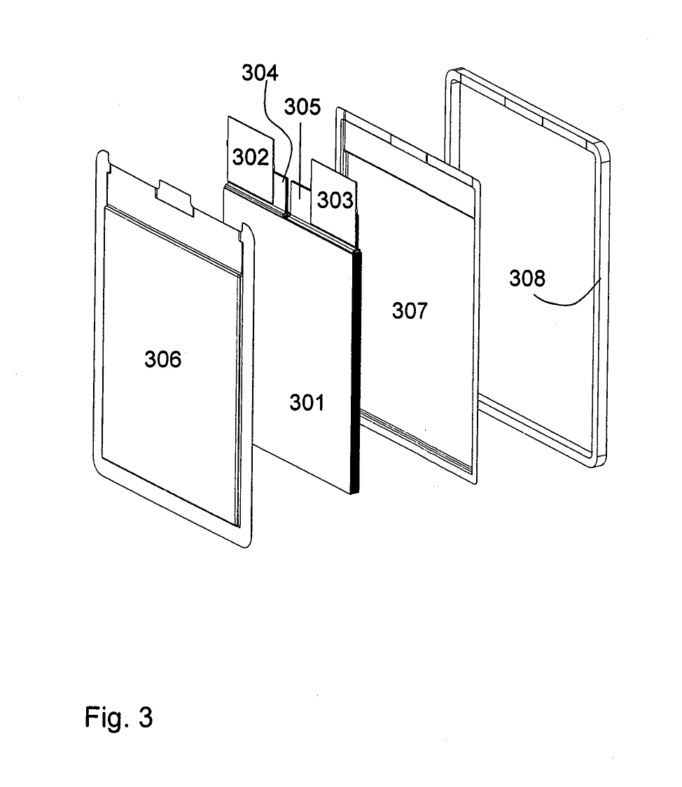

FIG. 3 shows an exploded view of this cell from the front and

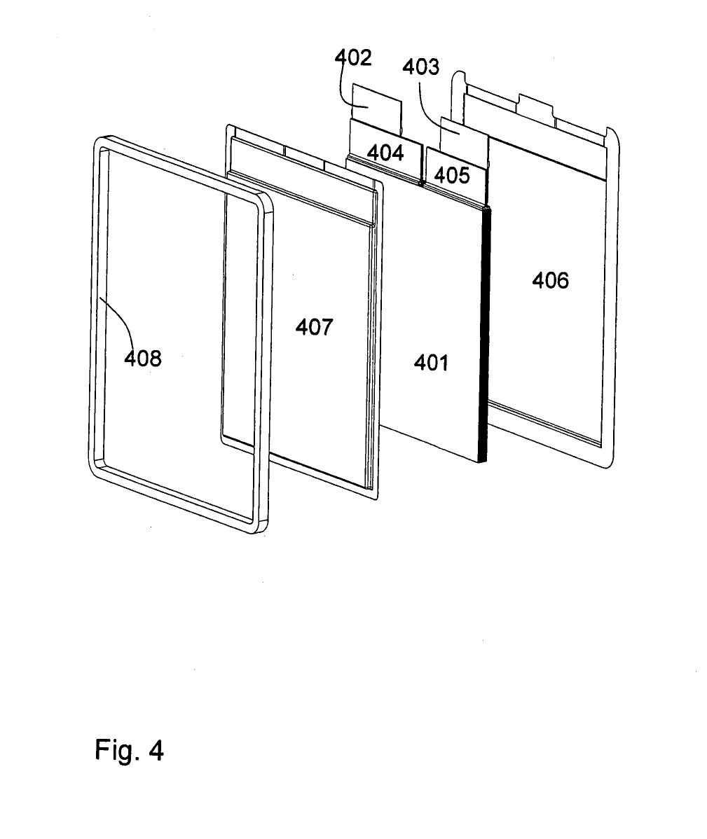

FIG. 4 shows an exploded view of this cell from the rear;

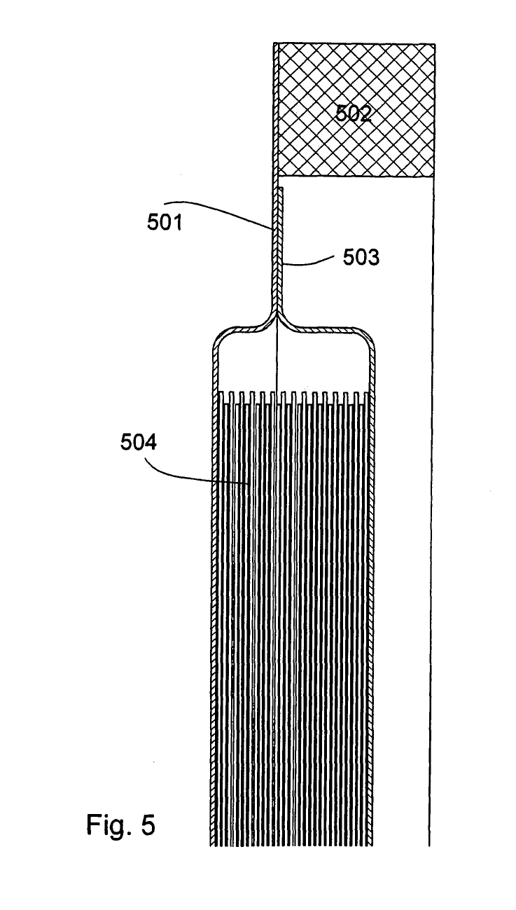

FIG. 5 shows an embodiment of the invention, wherein the frame is welded to the outwardly extended inner side of the package foil;

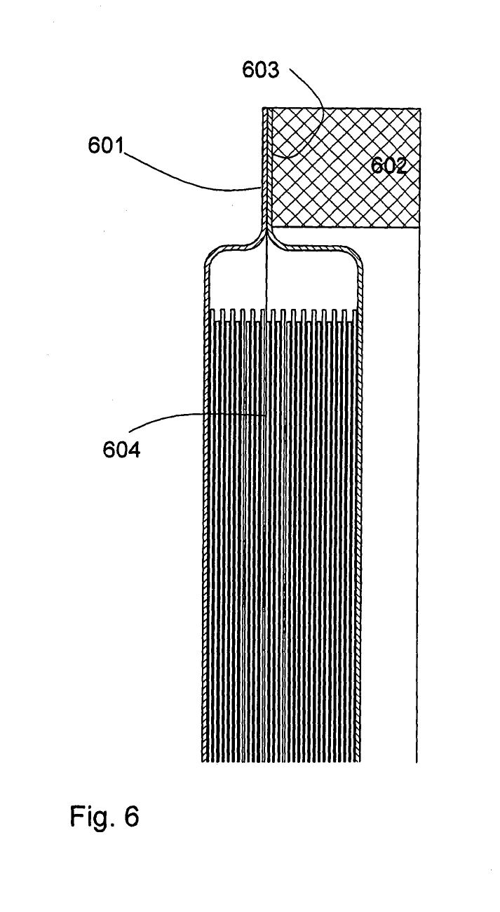

FIG. 6 shows an embodiment of the invention, wherein the frame is welded to the outer side of the package foil in the region of the sealing of the two foils;

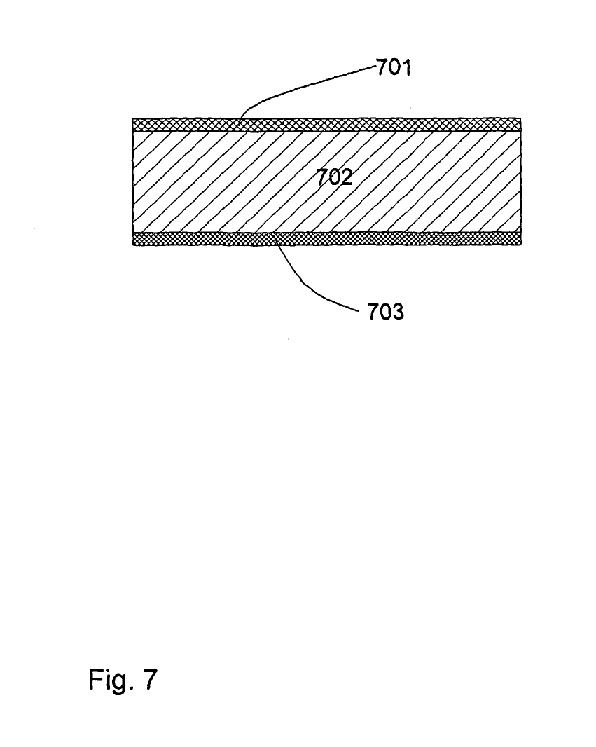

FIG. 7 shows the basic structure of a typical package foil of galvanic cells;

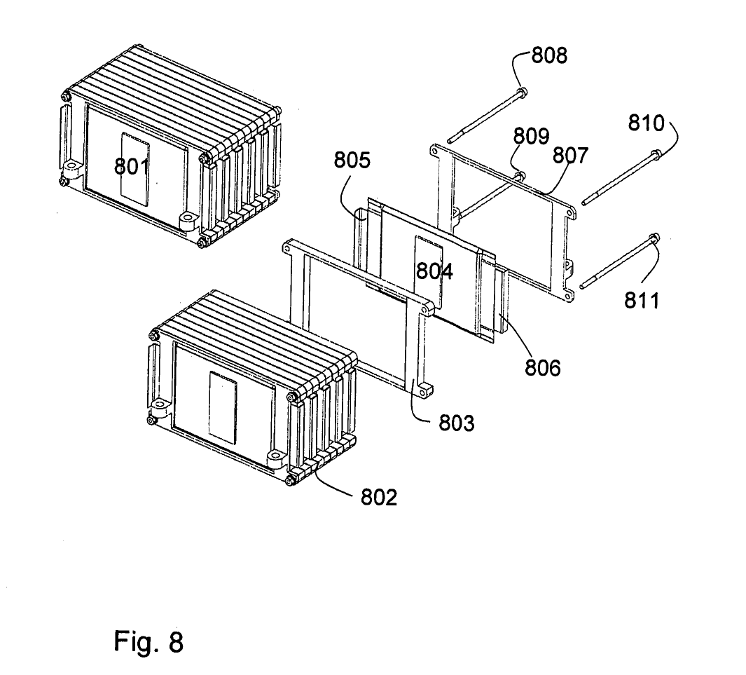

FIG. 8 shows the structure of a cell block comprising galvanic cells according to an example of embodiment of the present invention;

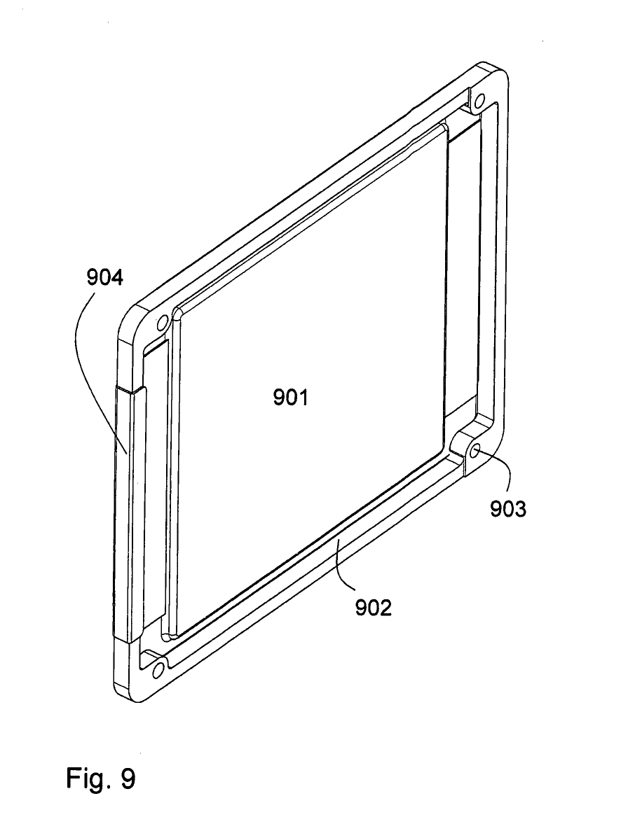

FIG. 9 shows a view of a galvanic cell according to an example of embodiment of the present invention with a frame comprising holes for a tension anchor and current collectors, which are partially bent around the frame and contacted in a friction-locked manner;

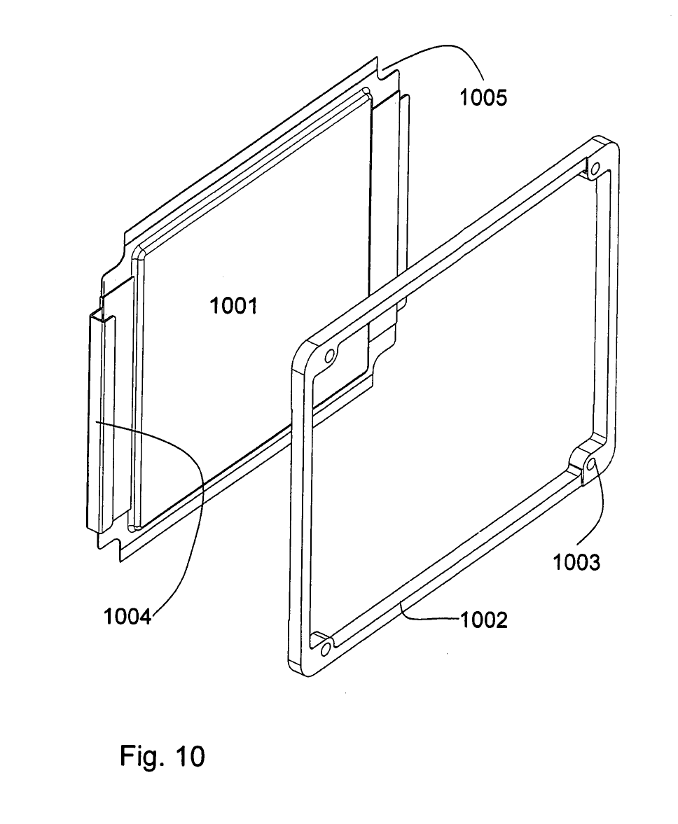

FIG. 10 shows an exploded view of the cell shown in FIG. 9;

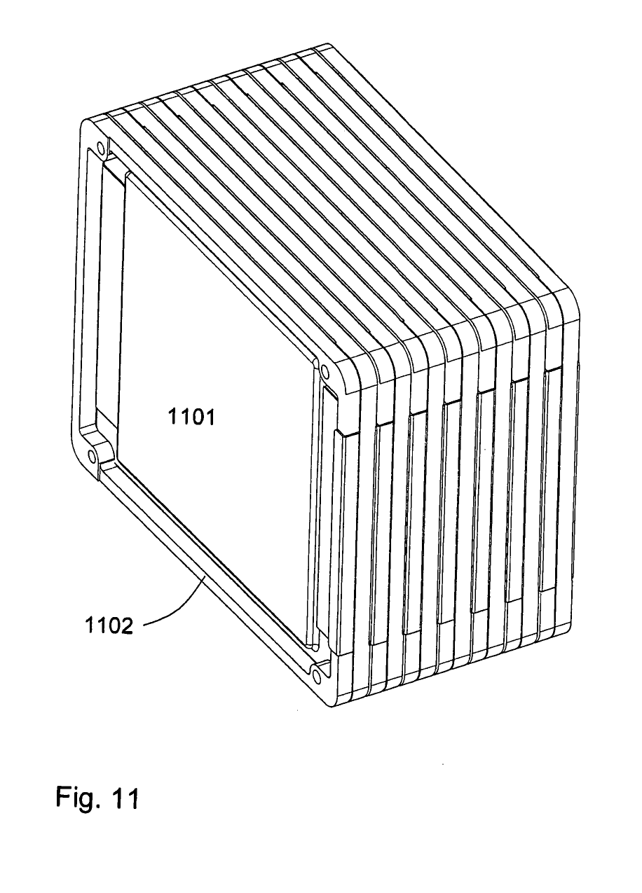

FIG. 11 shows the view of a cell block comprising individual cells, wherein the tension anchor has not been represented;

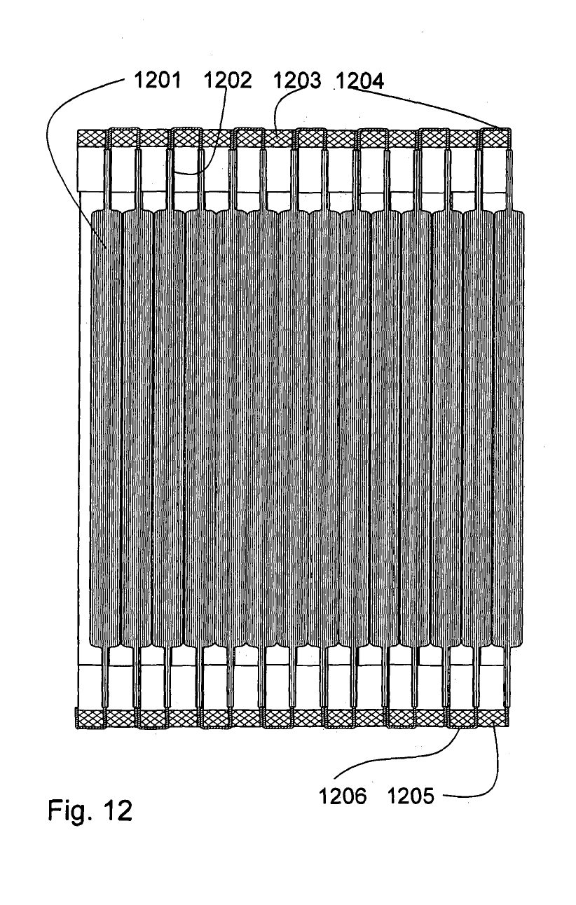

FIG. 12 shows a cross-sectional representation of the cell block shown in FIG. 11;

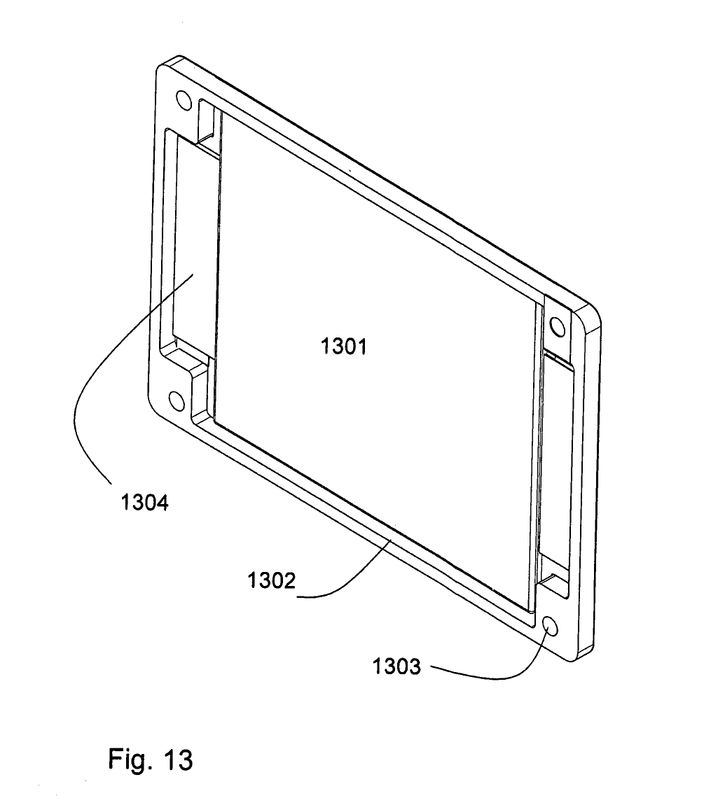

FIG. 13 shows the view of a cell according to the invention according to a further example of embodiment, wherein the current collectors are led out parallel to the weld seam of the foil and are contacted in a friction-locked manner;

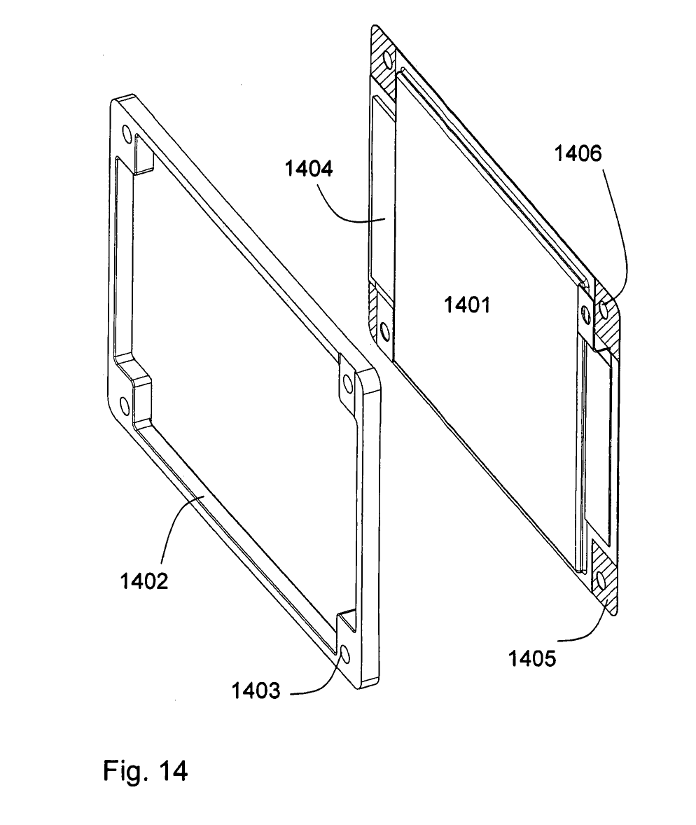

FIG. 14 shows an exploded view of the cell shown in FIG. 13;

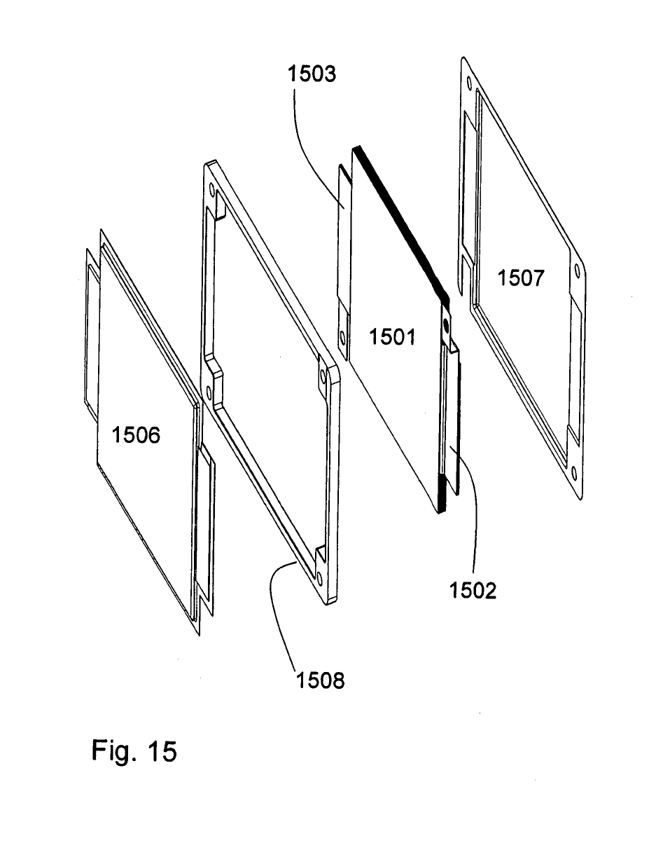

FIG. 15 shows a further exploded view of this cell;

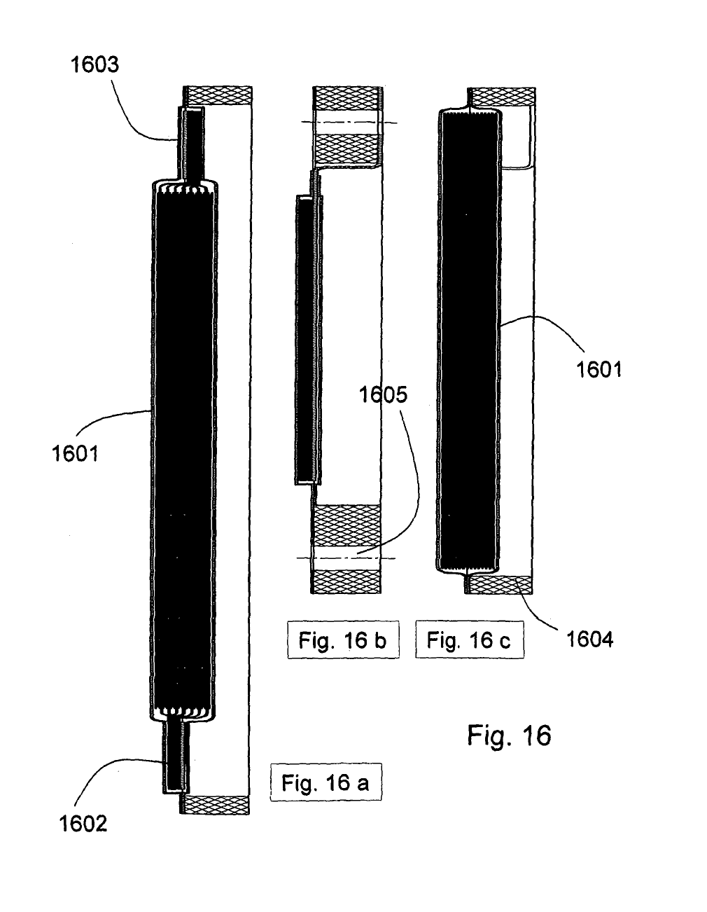

FIG. 16 shows various cross-sectional drawings through a galvanic cell according to an example of embodiment of the invention and a sketch of cross-section locations;

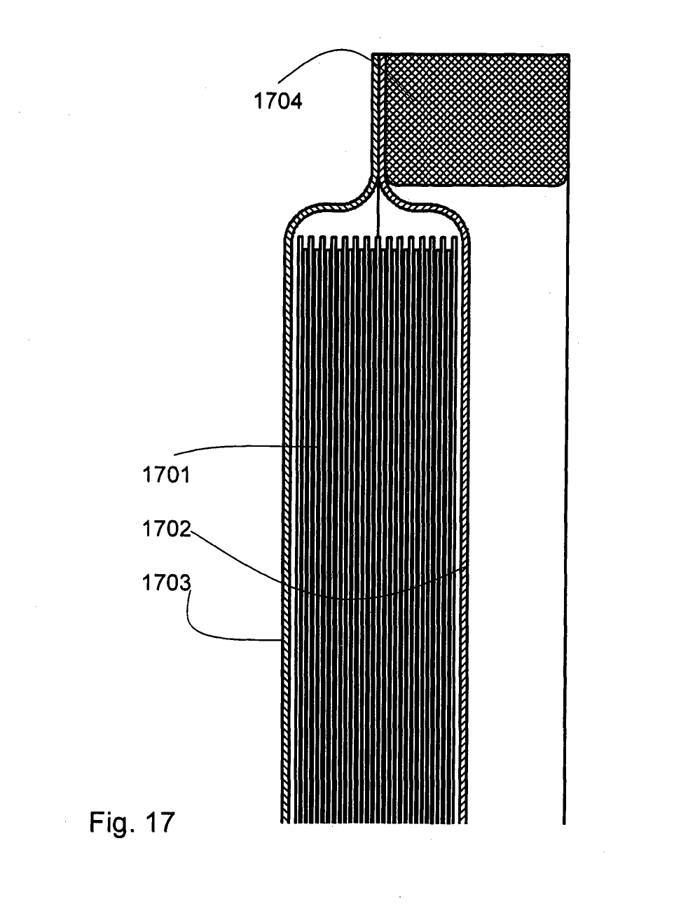

FIG. 17 shows a cross-sectional representation through a cell according to an example of embodiment of the invention with an enlargement of the frame region;

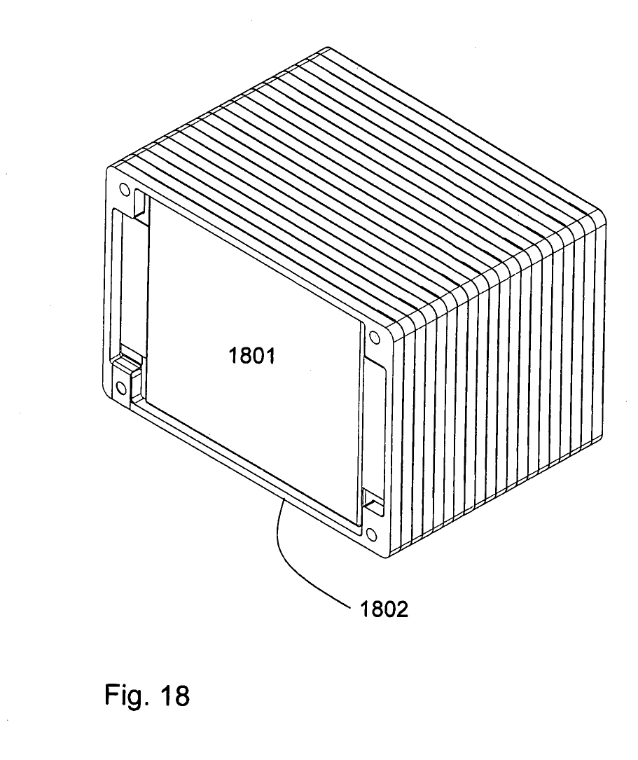

FIG. 18 shows a cell block comprising cells according to FIG. 13;

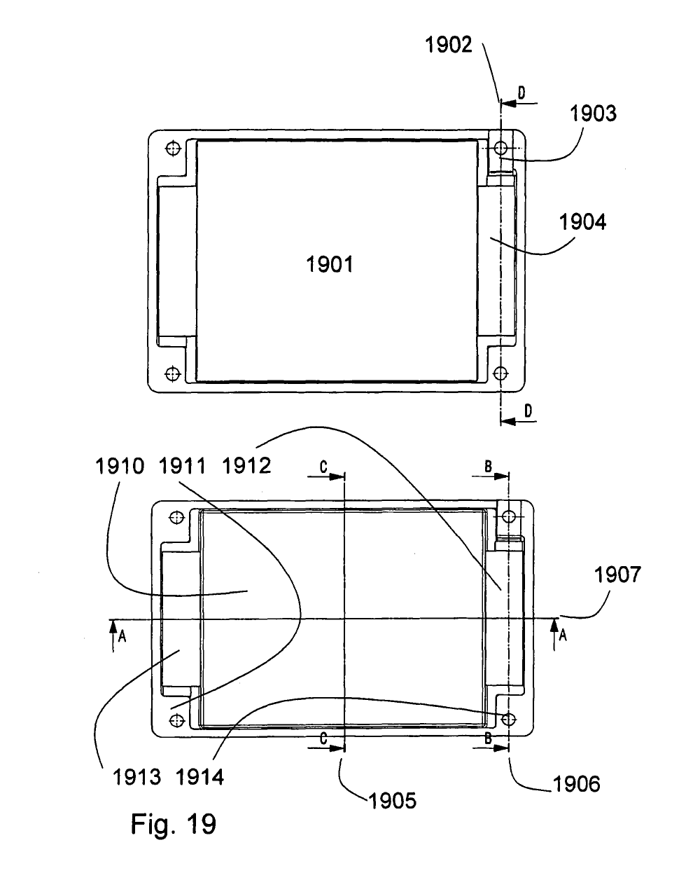

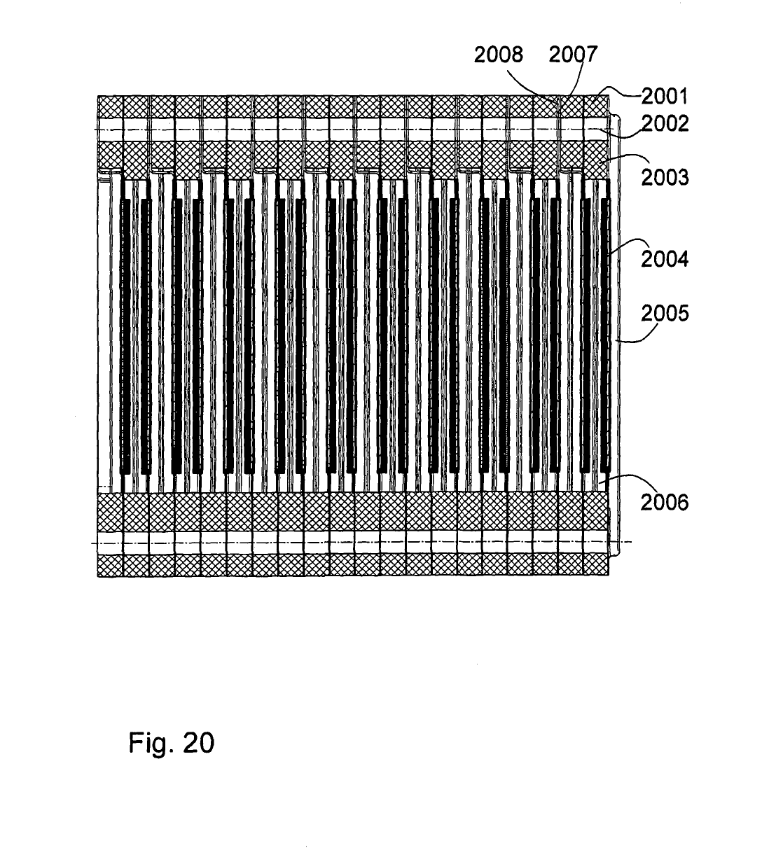

FIG. 19 shows a sketch of cross-section locations to clarify the cross-section location in the generation of the cross-section represented in FIG. 20 and a further sketch of cross-section locations to clarify the cross-section location in the generation of the cross-section represented in FIG. 16.

FIG. 20 shows a cross-sectional representation through the cell block represented in FIG. 18;

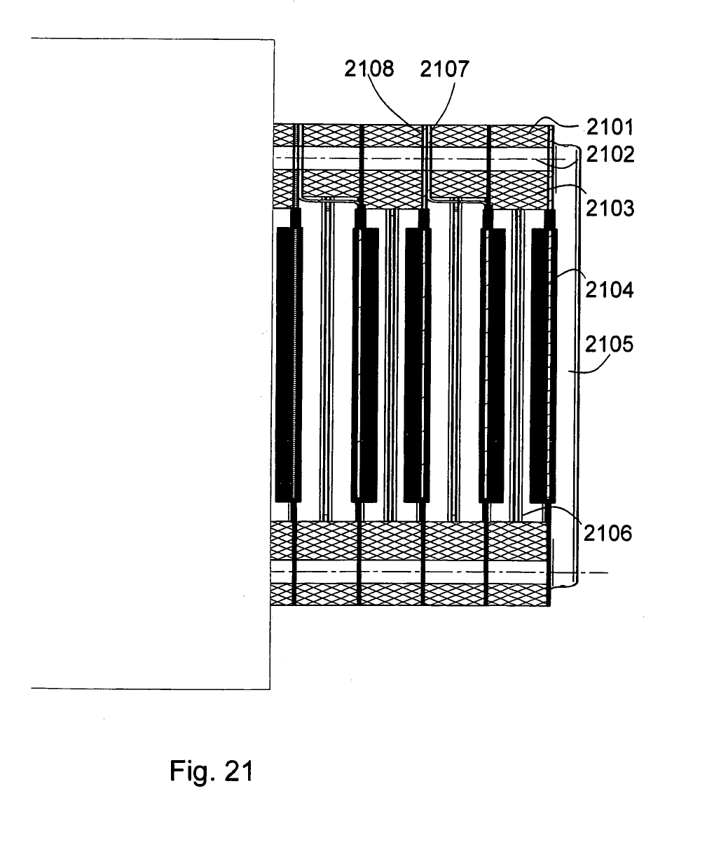

FIG. 21 shows an enlarged detail of the representation in FIG. 20;

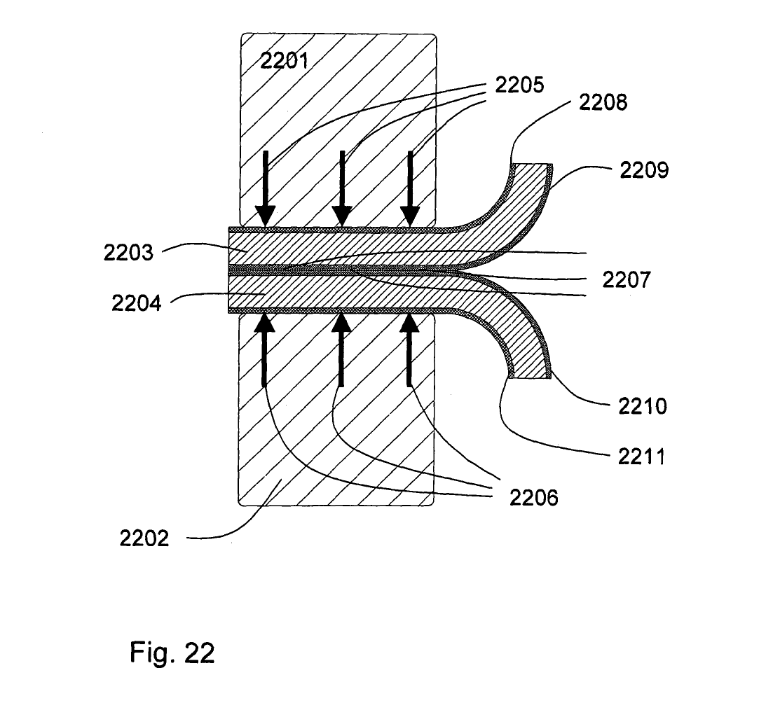

FIG. 22 shows the welding of the edge of a pouch cell between 2 sealing bars (prior art)

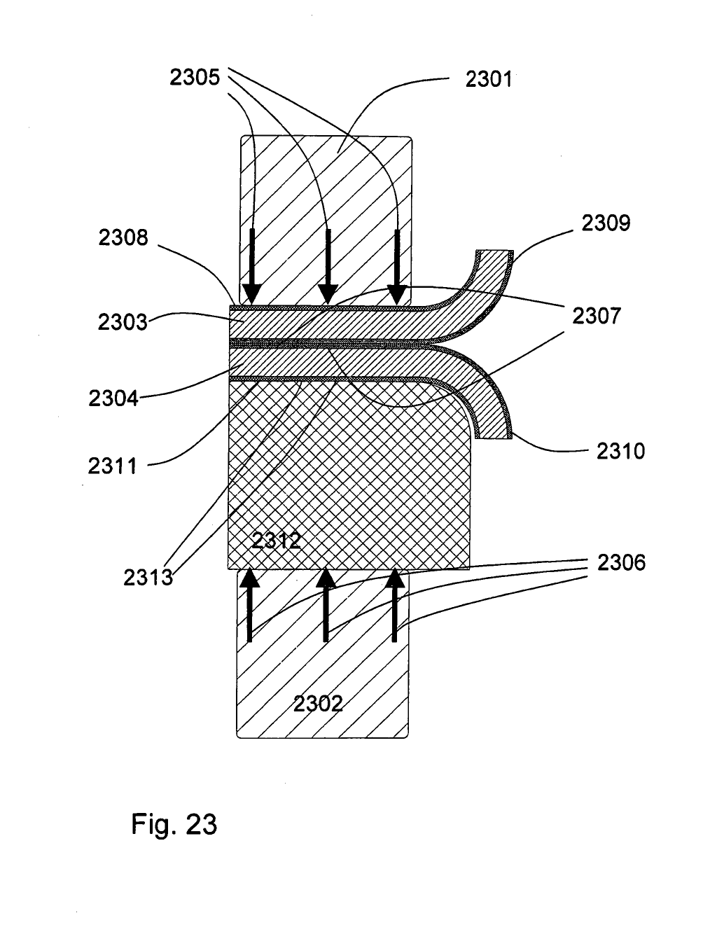

FIG. 23 shows a diagrammatic representation of the welding of a pouch cell to a frame according to an example of embodiment of the invention, wherein the connection of the outer side of the package foil of the cell to the frame is carried out simultaneously with the sealing of the cell;

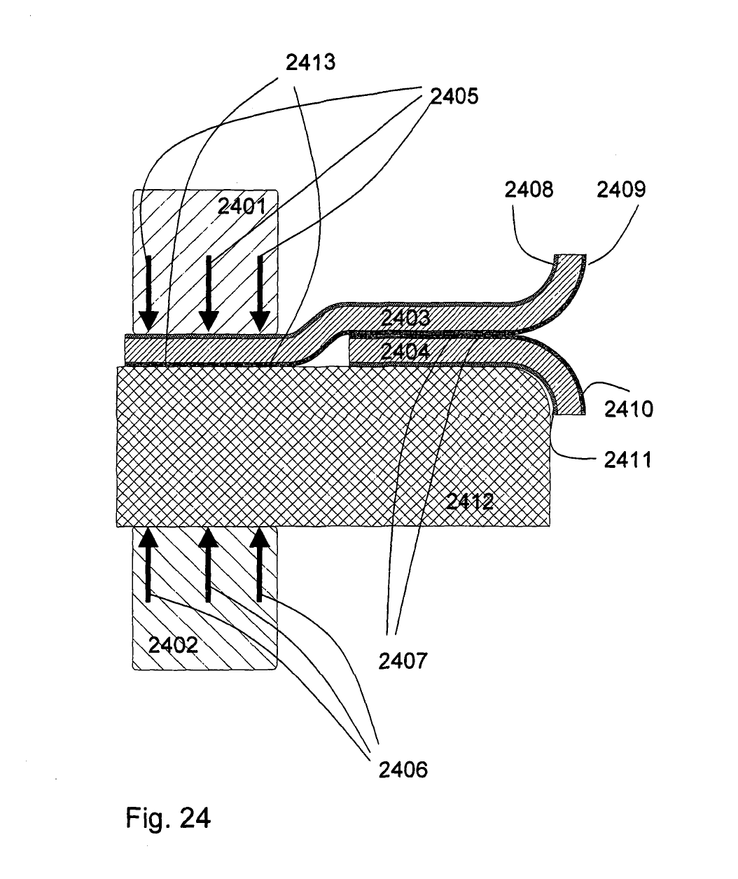

FIG. 24 shows a diagrammatic representation of the welding of a pouch cell to a frame according to an example of embodiment of the invention, wherein the connection of the inner side of the package foil of the cell to the frame is carried out after the cell has previously been welded up;

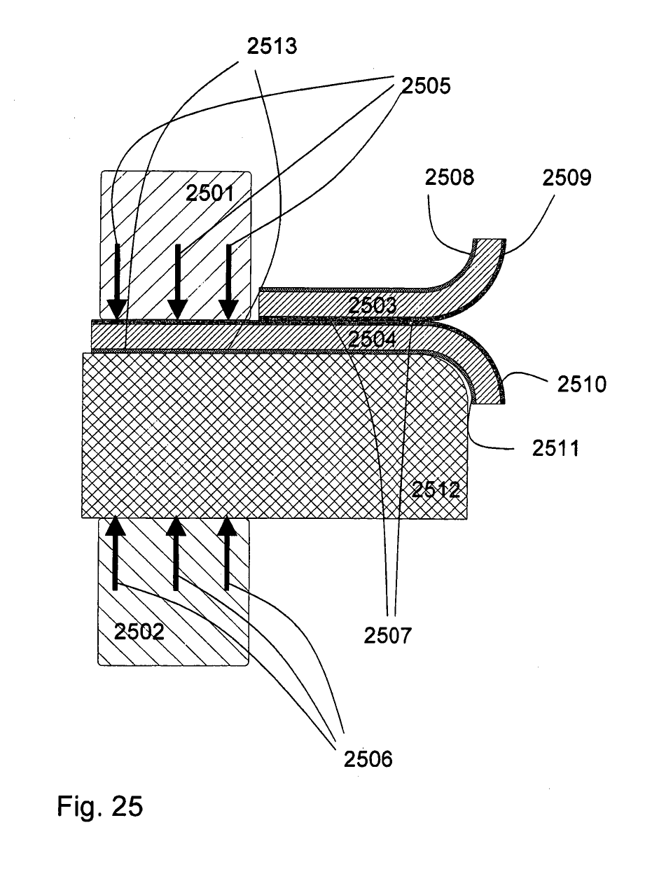

FIG. 25 shows a diagrammatic representation of the welding of a pouch cell with a frame according to an example of embodiment of the invention, wherein the connection of the outer side of the package foil of the cell to the frame is carried out after the cell has previously been welded up;

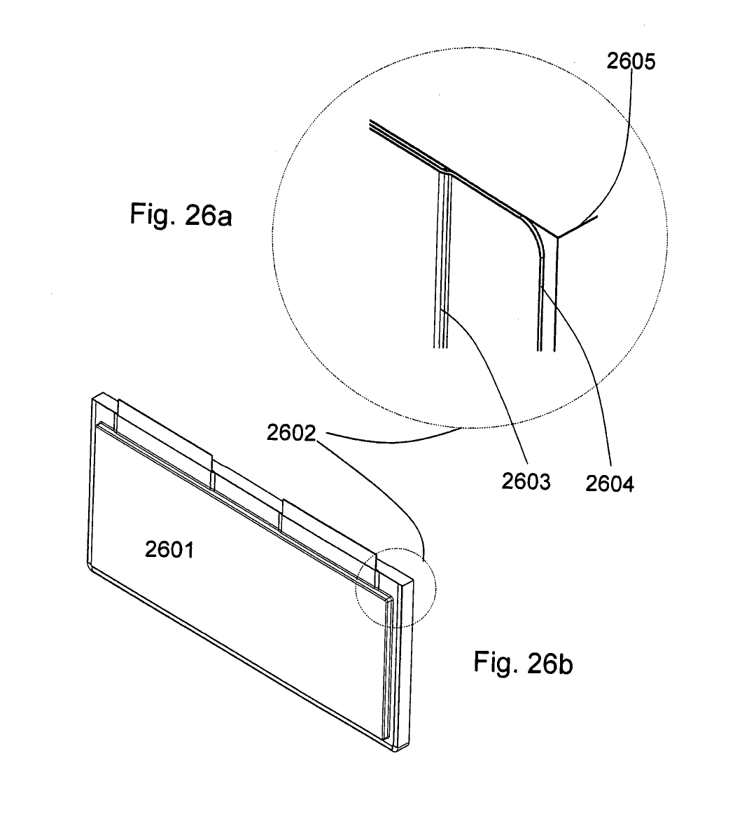

FIG. 26a shows in an oblique view the result of the welding of the inner side of the projecting package foil of the cell to the frame represented in FIG. 23, wherein the weld seam runs parallel to the cell;

FIG. 26b shows a detail enlargement of FIG. 26a;

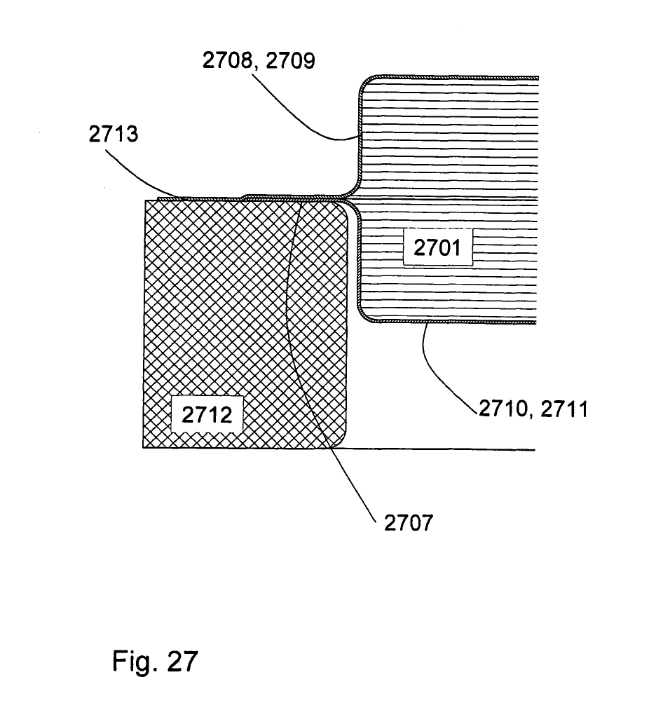

FIG. 27 shows a cross-section through the frame region of the embodiment represented in FIG. 26a;

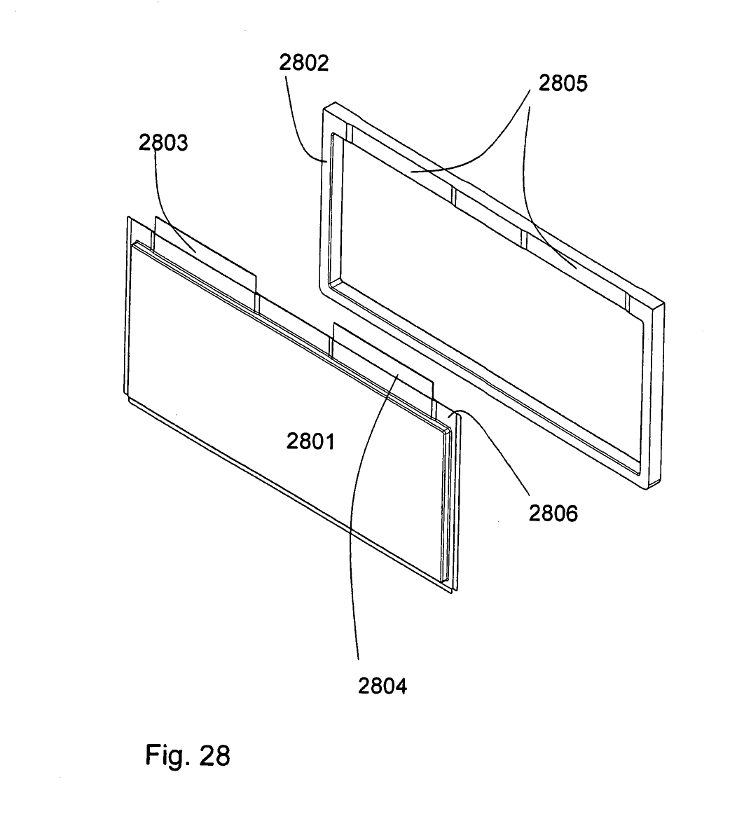

FIG. 28 shows an exploded view of the embodiment shown in FIG. 26a;

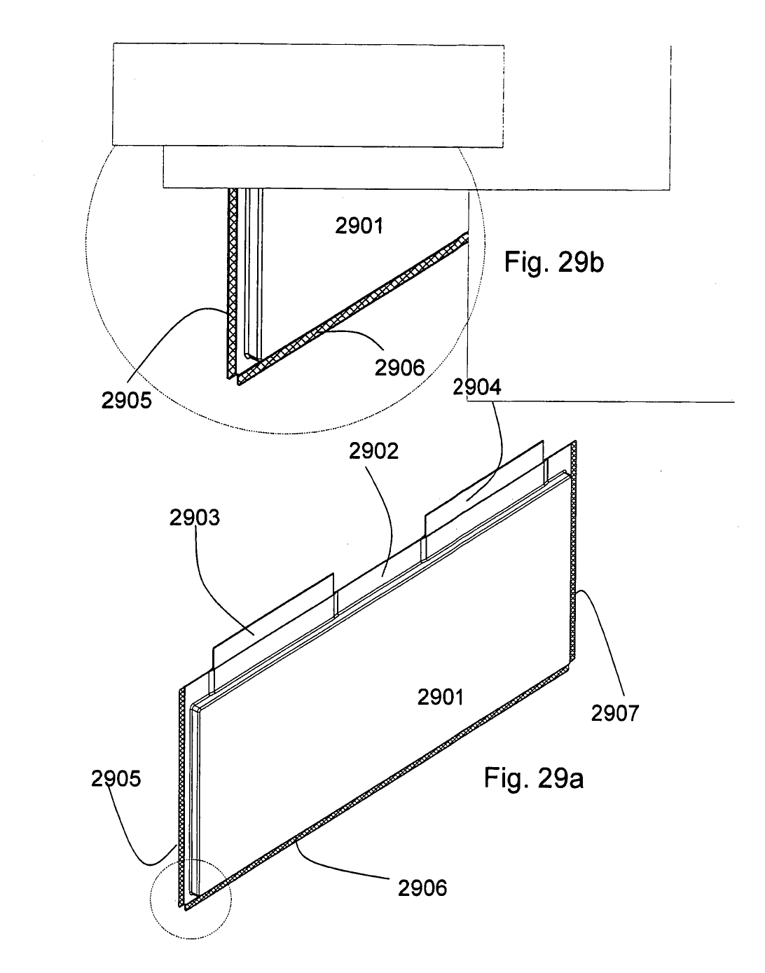

FIG. 29a shows a representation of the embodiment shown in FIG. 26a with a shaded representation of the jointing area with the frame;

FIG. 29b shows a detail enlargement of FIG. 29a;

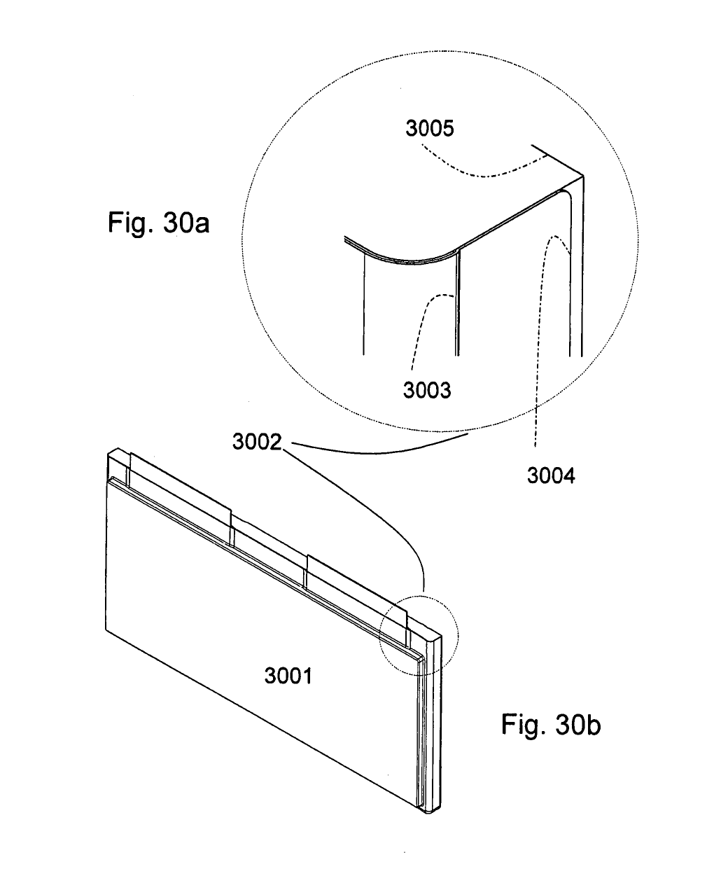

FIG. 30a shows in an oblique view the result of the welding of the inner side of the projecting package foil of the cell to the frame represented in FIG. 24, wherein the weld seam runs normal to the cell;

FIG. 30b shows a detail enlargement of FIG. 30a;

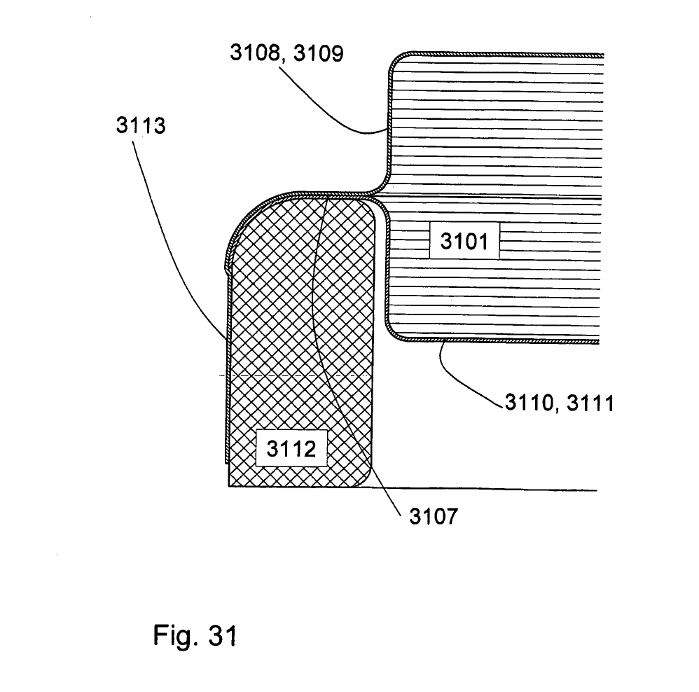

FIG. 31 shows a cross-section through the frame region of the embodiment represented in FIG. 30a;

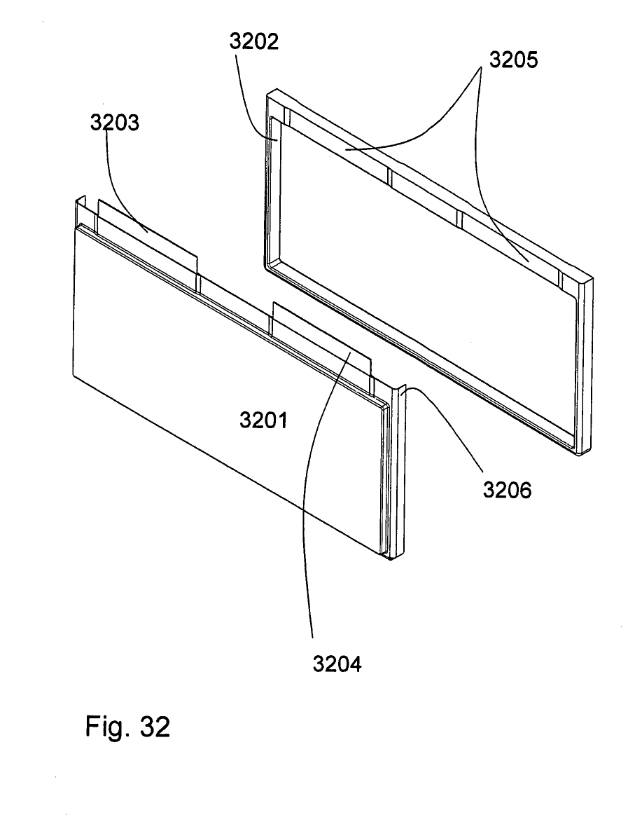

FIG. 32 shows an exploded view of the embodiment shown in FIG. 26a;

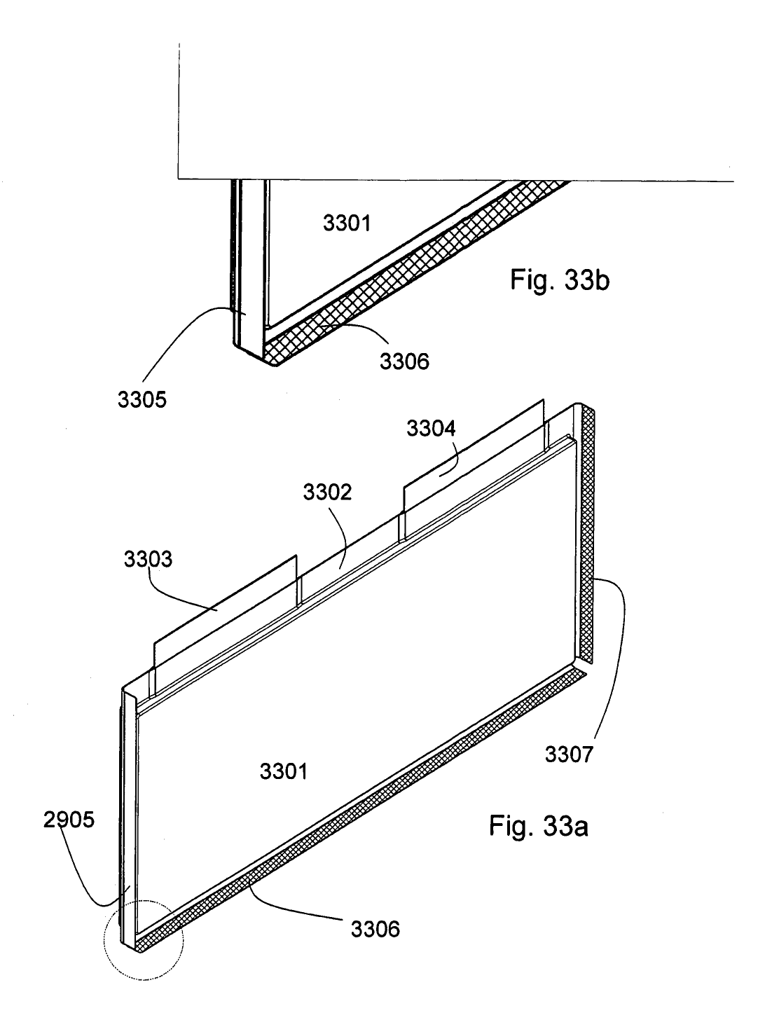

FIG. 33a shows a representation of the embodiment shown in FIG. 30a with a shaded representation of the jointing area with the frame; and

FIG. 33b shows a detail enlargement of FIG. 33a.

The invention proceeds from a galvanic cell which essentially comprises an electrode stack with a foil-type package, from which at least two current collectors are led out. According to the invention, such a galvanic cell is stabilised by a frame, which is constituted such that it can be fixedly connected to the package of the cell during the production of the cell. With a suitable constitution of several embodiments of the invention, the advantage arises that the galvanic cells are not stabilised only when assembled in a battery by a connection to a frame or mount that then has to be produced, but that the cell is already stabilised by the frame according to the invention before being assembled in a cell block. The method according to the invention, according to which the frame is already connected to the cell when the package is sealed, further has the advantage that the cell is already protected against mechanical influences in the subsequent production process, i.e. during its filling, during the forming, during the planned ageing or during the so-called “grading”.

Depending on the intended use, firm-bonding methods in particular, such as for example gluing or similar methods, are suitable for producing the inventive frame connection of the cell. The frame can preferably also be connected to the package foil by hot pressing or hot sealing, which is preferably carried out by partial melting of a thermoplastic layer present between the jointing partners with subsequent cooling under compressive force, said package foil often being provided in any case with a corresponding coating suitable for this.

The term hot sealing is understood to mean a method for joining thermoplastic melting layers of packaging materials (e.g. laminated foils), preferably by hot pressing. In packaging technology, hot sealing is an important method for welding foils. A distinction is made essentially between the following two variants:

a) sealing with a heated rod or heated rule between sealing jaws, also referred to as contact sealing, and

b) impulse sealing.

In the first variant, a preferably mobile sealing jaw carries a heated rod. A preferably fixed lower sealing jaw is often provided with a surface made from an elastic material in order to compensate for unevennesses in the sealing seam. Sealing elements of this kind are used in many machines commonly available on the market for the production and for the sealing of bags and in moulding, filling and sealing machines.

In the case of very long sealing seams, the heated rods often have to be worked with extremely high dimensional precision and without any deviation, in order to ensure a uniform pressure over the whole sealing area. In order to obtain clean sealing seams, the foils are often rendered flat with the aid of stretching devices before entry into the sealing tool. Another possibility is the use of heated rods with a saw-like sealing surface, but then there is the risk of hole formation.

Silicone rubber has been tried and tested for the resilient surface of the fixed, cold sealing jaw. This counter-pressure bar is often provided with a slightly arched shape. In the sealing process, there is first built up in the middle of the sealing seam a pressure which is propagated to the edges when the tool is closed. An optimum sealing seam is thus intended to be produced. Moreover, no liquid droplets should be pressed out from the sealing region, which would destroy the sealing seam due to the emergence of water vapour.

In the case of impulse sealing, the temperature of the sealing bars is maintained only for a rather short moment and not over the whole sealing cycle. The required heat is generated by two small resistance elements on both sealing jaws.

As soon as the sealing tool is closed over the foil to be sealed, the welding is carried out by means of a short current surge. In comparison with heated rod sealing, the period of the heat action is shorter and the excess heat is immediately conducted away. The sealing area of the tool can also be covered by a thin, insulating foil of heat-resistant material in order to prevent the sealed material from sticking.

As a result of the large-area connection of the package foil with the frame, mechanical stress speaks, which could otherwise easily arise with loading of the structure, can for the most part be avoided. The connection to the frame can be carried out at the inner side of the package foil, which is often coated with polypropylene. FIG. 5 shows such a connection of the frame to the inner side of the package foil.

According to another embodiment of the invention, it is also possible to connect the frame to the outer side of the package, which is often coated with polyamide. Such an embodiment of the invention is represented in FIG. 6.

Furthermore, it is advantageous to carry out the sealing of the cell, i.e. the connection of the two parts of the package foil, and the connection to the frame in one work step.

In order to simplify the structure of a cell block comprising galvanic cells according to the invention, it is advantageous and therefore preferred to provide the frame with corresponding shaped elements, such as for example protrusions or depressions, which are disposed, for example, on two sides of the frame, in such a way that the corresponding shaped elements can engage into one another in a matching manner and thus assist the assembly of the cell block by promoting the alignment of the cells in the intended manner.

The frame according to the invention can preferably be provided at suitable points with holes or other perforations, through which tension anchors can be introduced which hold the cell block together.

FIGS. 1 to 4 show a preferred example of embodiment of the invention, wherein the frame is preferably made of plastic and connected to the inner side of the package foil by means of hot pressing. In this example of embodiment, the half of the package foil connected to the frame is present peripherally beyond the other half, as is represented in FIG. 5.

FIG. 1 shows a three-dimensional view of a cell according to this example of embodiment with an integrated frame 102, which is connected to the package of cell 103. Current collectors 101 of the cell project out of the package. FIG. 2 shows the same cell from the other side. Accordingly, reference numbers 201, 202 and 203 denote the current collector, the frame and the package of the cell. An exploded view of this cell with an integrated frame is shown in FIG. 3. Cell stack 301, with which the cell header is connected electrically to its two electrode bundles 304, 305, and to which current collectors 302, 303 are fitted, is closed on both sides by a package foil with parts 306 and 307, which is mechanically stabilised by a frame 308. A corresponding exploded view from the other side is shown in FIG. 4. Here too, electrode stack 401 with electrode bundles 404, 405 and current conductors 402, 403 fitted thereon is enveloped and enclosed by the two parts 406, 407 of the foil package and stabilised by frame 408.

The basic structure of a typical package foil for galvanic cells is shown in FIG. 7. An aluminium foil 702 is coated on one side with a polyamide 701 and on the other side with a polypropylene 703. Other foils with other materials, layers or coatings are of course possible.

A preferred embodiment of a cell block comprising galvanic cells according to the invention with an integrated frame is shown in FIG. 8. A complete cell block 801 is assembled in that there are added to a cell block 802 in the course of being assembled further cells, such as for example the cells provided with reference number 803 with frames. Cell 803 comprises actual cell 804 with current collectors 805, 806, which is connected in a friction-locked manner to a frame 807. In order to stabilise the whole cell block, tension anchors 808, 809, 810 and 811 lead through corresponding holes in the frames.

If the frames are constituted such that they are provided with structures such as, for example, protrusions or grooves that facilitate centring or alignment of the cells, the passage of the tension anchors through the holes is then also considerably facilitated. In this embodiment, the current collectors are wrapped or bent around the frames in a weight-saving manner, as a result of which a solid contact strip becomes unnecessary.

FIG. 9 shows a detailed representation of such a cell with current collectors which are wrapped around the frames. Cell 901 has a current collector 904 which is wrapped around frame 902. The frame is provided with a hole 903 for the passage of tension anchors. FIG. 10 shows the same cell in an exploded view. Unlike as represented in the figure, current collector 1004 is bent around the frame only after said frame 1002 has been fitted. FIG. 11 shows a cell block comprising galvanic cells of this embodiment.

FIG. 12 shows a cross-sectional representation of the cell block shown in FIG. 11. Fitted at cell header 1202 of cell 1201 is a current collector 1204, which is bent around frame 1205 and makes electrical contact with a current collector of the adjacent cell. The opposite-lying current collector of cell 1201 is not bent around frame 1205 and is therefore electrically insulated from current collector 1206 of the adjacent cell, which in turn makes electrical contact with a current collector of the next adjacent cell. In this way, it is possible to achieve an electrical circuitry of the current collectors in the cell block structure in the intended manner virtually without further aids.

An embodiment of the invention shown in FIG. 13 requires still less space. Current collectors 1304 of cell 1301 are led out from the package parallel to the weld seam and are contacted in a friction-locked manner. Frame 1302 comprises a hole 1303 for the passage of a tension anchor. An exploded view of this embodiment is shown in FIG. 14. The package of cell 1401 comprises at its corners special faces 1405 which are suitable for hot-pressing with frame 1402. Current collectors 1404 of the cell are positioned in such a way that contacting takes place automatically in the intended manner. The package corners of the cell can further be provided with holes 1406 for the passage of a tension anchor, which are positioned congruently with corresponding perforations 1403 in frame 1402. An exploded view of this example of embodiment is shown in FIG. 15. Electrode stack 1501 with current collectors 1502, 1503 is enclosed between an upper part 1506 of the package, a frame 1508 and a lower part 1507 of the package. The upper part and lower part of the package are provided with shaped elements represented in FIG. 15, which assist automatic contacting of the current collectors in the intended manner.

FIG. 16 shows three different cross-section locations 16a, 16b and 16c through a galvanic cell represented in the lower part of FIG. 19. FIG. 16a shows the cross-section according to the cross-section location along line 1907, FIG. 16b the cross-section according to the cross-section location along line 1906 and FIG. 16c the cross-section according to the cross-section location along line 1905. FIG. 16a shows cell stack 1601 with cell headers 1602 and 1603, FIG. 16b shows perforation 1605 through frame 1604 and FIG. 16c shows the cross-section through the cell located normal to FIG. 16a.

FIG. 17 shows an enlarged cross-sectional representation of the frame region of this example of embodiment of the invention. It represents frame 1704, which is connected to both parts of package foil 702, 703 of cell 701. FIG. 18 shows a cell stack comprising cells according to this embodiment of the invention. FIG. 20 shows a cross-section through the cell block with the cross-section location represented in the upper part of FIG. 19. FIG. 19 shows an enlargement of a detail from this cross-sectional representation, in which it can be seen more clearly than in FIG. 20 that the space is used somewhat more efficiently in this embodiment of the invention. A virtually gap-free structure of the cell block is enabled by the special design of current collector 2107, which can be seen in the upper part of FIG. 21 and which makes electrical contact with current collector 2108 of the adjacent cell. Cell stack 2104, the underside of package 2105, the upper side of package 2106, frame 2101 and 2103 with perforation 2102 can be seen.

In order to produce a galvanic cell according to the invention, the frame and the package, preferably the package foil, are preferably placed one upon the other and pressed together, for example by heatable stamps or sealing bars, i.e. they are preferably hot-sealed together under the effect of external forces or connected together adhesively or cohesively in another way. This mode of procedure preferably leads to the partial melting of the thermoplastic layer preferably present on the package foil and/or to the partial melting of the surface of the frame. For this purpose, the frame, in the jointing area for example, is preferably also produced from a thermoplastic material.

Thermoplastics, which also referred to as plastomers, are plastics which can be deformed under the effect of heat in a specific temperature range. This deformation can often be reversed, i.e. it can be repeated after cooling by reheating, for example until the molten state, as long as thermal decomposition of the material does not occur due to overheating. In this property, thermoplastics differ from so-called thermosetting plastics and elastomers. A further characteristic feature of thermoplastics is the weldability of these materials.

Thermoplastics can be welded under the effect of heat and pressure. The materials to be welded are heated above their melting temperature and brought into a free-flowing state.

After the heating of the participating components, the cooling of these materials can preferably be accelerated by an actively coolable sealing bar or an actively coolable stamp. Such actively coolable stamps are described for example in U.S. Pat. No. 4,145,485. The stamps described in this publication, however, are coolable only in a partial region, in which the electrochemically active parts of the cell need to be protected against overheating in the process of hot sealing.

The stamps or sealing bars described in this publication are not coolable in the region in which the heating takes place during the hot sealing. In order to enable efficient cooling of the sealing bars in the phase of the cooling also in the region of the hot sealing, the present invention makes provision, according to an example of embodiment, to beat the sealing bars for example by means of hot air and to cool the same by means of cool or cooled air. A rapidly occurring sequence of temperatures in the stamps or sealing bars can be achieved by successively occurring blowing-in of hot air or cold air in cooling channels in the stamp or sealing bar. Instead of air, use may also be made of other heat transport media, such as for example water or rather fluids, which are particularly well suited for the transport of heat.

According to embodiment of the invention, the successively occurring heating and subsequent cooling of individual points of a tool used for the hot sealing can also be combined with the permanent cooling in the planar region of the two-dimensionally extending galvanic cell, as described in the US 4,145,485, with the purpose of protecting the electrochemically active parts of the cell against overheating.

The welding or the hot sealing of the package to the frame preferably takes place solely under the effect of heat and the effect of external compressive forces without further additives. Due to a large-area connection of the package foil with the frame, the emergence of mechanical stress peaks can be avoided when the structure undergoes mechanical loading. The connection of the foil to the frame can preferably be carried out at inner side 703, 2309, 2310, 2409, 2410, 2509, 2510 of the package foil, which is often coated with polypropylene. One side of the package foil preferably projects for this purpose - as shown for example in FIG. 24 or 25.

According to an alternative embodiment of the invention, provision is made such that outer side 701, 2308, 2311, 2408, 2411, 2508, 2511 of the package foil is provided for the connection to the frame, which is often coated with polyamide. Outer side 701, 2308, 2311, 2408, 2411, 2508, 2511 of the package foil is preferably also coated with polypropylene or another suitable thermoplastic material which, in the hot sealing process, enters into a firmly bonded connection with the frame.

In other embodiments of the invention, provision is made to constitute frame 2312, 2412, 2512 metallically. It is also possible in this case, through a suitable modification of the plastic coating, to produce a firmly bonded connection with the package. This preferably takes place in a single work step, in which the various parts of the package foil are connected to one another and simultaneously the latter are connected to the frame adhesively or cohesively.

In order to simplify the structure or the formation of the cell block comprising a plurality of galvanic cells, an example of embodiment of the invention makes provision to provide the frame with protrusions, depressions or recesses or other shaping elements, in such a way that the galvanic cells are orientated laterally offset with respect to one another during the formation of a cell block. It is preferable also to introduce into the frames holes for tension anchors which pass through and which align the cells and the frames during assembly and hold the cell block together following bracing.

FIG. 22 shows a diagrammatic representation of the welding of the package foil of the galvanic cell at its edge between two sealing bars 2201, 2202. Under the effect of compressive forces 2205, 2206 and simultaneous heating, sealing bars 2201, 2202 press the two sheets of the package foil against one another. The package foil preferably comprises a middle layer 2203, 2204, which is preferably made of aluminium foil, and to outer layers 2208, 2209, 2210, 2211, which are preferably made of polyamide 2208, 2211 and preferably of polypropylene 2209, 2210. In jointing zone 2207, the polypropylene is partially melted by the heat effect, as a result of which the firmly bonded connection of the two parts of the cell package takes place. This kind of cell sealing is known in principle.

FIG. 23 shows diagrammatically an example of embodiment of the welding of the package foil to the frame according to the invention with simultaneous sealing of the package of the cell, preferably in a single work step. Sealing bars or stamps 2301, 2302 press together the two leaves of package foil 2208, 2309, 2303, 2304, 2310, 2311 with the aid of compressive forces 2305, 2306 and under the effect of heat and also press frame 2312 against outer side 2311 of the package foil. Under the effect of the compressive forces and the heat, there takes place in jointing zone 2307 between the two leaves of the package foil and in jointing zone 2313 through between the package foil and the frame a partial melting of the thermoplastic materials present there, which leads to a firmly bonded connection between the leaves of the package foil on the one hand and between a leaf of the package foil and the frame on the other hand in one work step. Instead of a heated sealing bar 2302 on the side of the frame, a simple counter-support can also be provided at this point.

In the further example of embodiment of the present invention shown in FIG. 24, the two leaves 2403, 2404 of the package foil are welded up or otherwise connected to one another adhesively or cohesively at their inner sides 2409, 2410 in a first step. In a second step, the firmly bonded connection with frame 2412 takes place, preferably by hot sealing with the aid of sealing bars 2401, 2402 which, with the application of external forces 2405, 2406 and under the effect of heat, press inner layer 2409 of the projecting leaf of the package foil of the cell against frame 2412 and weld or otherwise connect adhesively or cohesively layer 2409 in jointing zone 2413, preferably by partial melting of thermoplastic materials, to frame 2412.

Not represented in FIG. 24 is a combination of the examples of embodiment represented in FIGS. 23 and 24. With this advantageous combination, coating 2411 of package foil 2404 is also connected to the frame adhesively or cohesively in the jointing zone located between layer 2411 and frame 2412, beneath jointing zone 2407. Further mechanical stabilisation of the galvanic cell can thus be achieved with the aid of the frame.

FIG. 25 shows diagrammatically a further example of embodiment of the invention, wherein lower leaf 2504 of the package foil projects beyond upper leaf 2503 and has been connected adhesively or cohesively to this upper working leaf in a first work step. In a similar manner to that in the preceding examples of embodiment, the firmly bonded connection of lower leaf 2504 of the package foil to frame 2512 takes place in jointing zone 2513, wherein stamps 2501, 2502 press projecting leaf 2504 against frame 2512 under the effect of greater forces 2505, 2506 under the effect of heat. Outer foil 2511 and preferably also a corresponding thermoplastic layer on frame 2512 are partially melted in jointing zone 2513, as a result of which a firmly bonded connection between the foil and the frame arises.

This example of embodiment can again be combined with the example of embodiment shown in FIG. 23 in a manner not shown here in the figures, wherein a firmly bonded connection can also be achieved in a further jointing zone lying below jointing zone 2517.

FIG. 26a shows, as a result of the described process steps, a galvanic cell 2601 and an enlarged detail 2602 in FIG. 26b. It is possible to see the welding of the inner side of projecting package foil 2604 to frame 2605 as well as edge 2603 in the package, which comes about due to the projection of the upper package foil beyond the lower package foil.

FIG. 27 shows a cross-sectional representation in the frame region of this example of embodiment, wherein the two leaves of the package foil with respective layers 2708, 2709, 2710, 2711 are connected to one another adhesively or cohesively in jointing zone 2707 and are connected to frame 2712 adhesively or cohesively in jointing zone 2713. A firmly bonded connection to the frame can also preferably be present in the region of jointing zone 2707 beneath the lower leaf of foil 2710, 2711, this preferably taking place by a combination of examples of embodiment shown in FIGS. 23 and 24.

FIG. 28 shows diagrammatically an exploded view of this example of embodiment with galvanic cell 2801, its current collectors 2803, 2804 and the edge of package foil 2806. Frame 2802 comprises special structural elements 2805, for example in the form of recesses in the frame, which correspond in their position to the arrangement of current collectors 2803, 2804, so that contacting of these current collectors can take place in the intended manner.

FIG. 29a shows an oblique view of the rear side of a galvanic cell according to this example of embodiment, wherein the jointing area with the frame is represented shaded. FIG. 29b shows a detail enlargement of the lower corner of this galvanic cell 2901 with jointing areas 2905, 2906, 2907 with the frame represented shaded. Current collectors 2903, 2904 of this cell 2901 partially project out of package foil 2902.

FIG. 30a shows the result of the production process illustrated in FIG. 24 in the form of a galvanic cell 3001 and detail enlargement 3002 in FIG. 30b. Frame 3005 and edges 3003, 3004 of the two leaves of the package foil can be seen.

FIG. 31 shows a cross-sectional representation in the frame region of the example of embodiment shown in FIGS. 30a and 30b. The two leaves of the package foil with inner and outer layers 3108, 3109 and respectively 3110, 3111 of galvanic cell 3101 are connected, preferably hot-sealed, to one another adhesively or cohesively in jointing zone 3107. The leaf with layers 3108, 3109 projects beyond the other leaf and is connected adhesively or cohesively to frame 3112 in jointing zone 3113.

FIG. 32 shows an exploded view of this example of embodiment with galvanic cell 3201, its current collectors 3203, 3204, partial package foil 3206, frame 3202 and the structures preferably provided on frame 3205, which are intended to assist correct use of current collectors 3203, 3204.

FIG. 33a shows an oblique representation of this example of embodiment, wherein the jointing area with the frame is represented shaded. FIG. 33b shows a detail enlargement of the lower corner of galvanic cell 3301 represented in FIG. 33A, current collectors 3303, 3304, package foil 3302 and the projecting edges of package foil 3305, which are represented shaded in their jointing zone 3306, 3207.

1.-19. (canceled)

20. A frame for a galvanic cell which essentially comprises an electrode stack with a foil-type package, from which at least two current collectors are led out, wherein the frame is constituted such that it can be fixedly connected to the package of the cell during the production of the cell adhesively or cohesively by means of a hot sealing process.

21. The frame according to claim 1, wherein the frame is constituted such that it can be fixedly connected to the package of the cell adhesively or cohesively by a hot sealing process during the production of the cell without an addition of additive substances.

22. The frame according to claim 21, which comprises structures which assist a flush alignment of cells provided with this frame during the assembly of a cell block.

23. The frame according to claim 22, which comprises structures which assist a laterally offset orientation of cells provided with this frame during the assembly of a cell block.

24. The frame according to claim 23, further comprising perforations for the passage of tension anchors during the assembly of a cell block.

25. A galvanic cell comprising the frame according to claim 1.

26. The galvanic cell according to claim 25, wherein its package is connected at its inner side to the frame.

27. The galvanic cell according to claim 25, wherein its package is connected at its outer side to the frame.

28. A method for producing a galvanic cell, wherein an electrode stack is enclosed in a foil-type package, from which at least two current collectors are led out, wherein a frame is fixedly connected to the package during the sealing of the package adhesively or cohesively by means of a hot sealing process.

29. The method according to claim 28, wherein an electrode stack is enclosed in a foil-type package, from which at least two current collectors are led out, wherein a frame is fixedly connected to the package during the sealing of the package adhesively or cohesively by means of a hot sealing process without an addition of additive substances.

30. The method according to claim 29, wherein the connection of the frame and the package is carried out by partial melting of a thermoplastic layer present between the jointing partners with subsequent cooling under a compressive force.

31. The method according to claim 30, wherein the frame and the package of the cell are placed one upon the other and pressed together by means of heatable stamps.

32. The method according to claim 31, wherein the subsequent cooling is accelerated by an actively cooled sealing bar.

33. The method according to claim 32, wherein the sealing of the package and the connection of the package to the frame takes place in one work step.

34. A method for the assembly of a block comprising a plurality of galvanic cells with the frame according to claim 22, comprising aligning the cells flush with the aid of structures of the frame.

35. A method for the assembly of a block comprising a plurality of galvanic cells with a frame according to claim 23, comprising orienting the cells laterally offset with the aid of structures of the frame.

36. A method for the assembly of a block comprising a plurality of galvanic cells with a frame according to claim 24, comprising stabilizing the block with the aid of tension anchors, which are passed through perforations in the frames of the cells.
